(19) United States
(12) Patent Application Publication
(10) Pub. No.: US 2012/0094089 A1
(43) Pub. Date: Apr. 19, 2012

(54) ULTRAVIOLET MARKING

(76) Inventors: Ngai NG, Hong Kong (CN); Kam Ho Chan, Hong Kong (CN)

(21) Appl. No.: 12/975,163

(22) Filed: Dec. 21, 2010

Related U.S. Application Data
(60) Provisional application No. 61/393,230, filed on Oct. 14, 2010.
(60) Provisional application No. 61/393,679, filed on Oct. 15, 2010.

(51) Int. Cl. B32B 3/10; B29C 47/00; H01B 7/36; B29C 45/16; B29C 47/06; B05D 5/12; B29C 47/02

(52) U.S. Cl. 428/195.1; 425/105; 427/64; 425/130; 264/255; 425/131.1; 264/171.1; 174/112

(57) ABSTRACT

An apparatus for UV marking a substrate comprises: an ink jet apparatus having UV sensitive ink, the ink jet apparatus being configured to eject the UV sensitive ink; and an extruder producing a wire and insulation in a processing direction. The ink jet apparatus is configured in relation to the processing direction so as to eject UV sensitive ink in a pattern onto a surface of the wire and insulation. Additionally, an apparatus for forming a UV marked product comprises: first and second injection devices; and a two layer mold injection unit at the output of the first and second injection devices. The first injection device uses a first mixture of a polymer, a color masterbatch, and a UV sensitive masterbatch, and the second injection device uses a second mixture of the polymer and the color masterbatch, and the first mixture and the second mixture are injected into the two layer mold to form a UV marked product having a UV sensitive section and a non-UV sensitive section. Further, methods related to UV marked or formed products and methods for recognizing legitimate products marked by the marking methods.

### CROSS-REFERENCE TO RELATED APPLICATIONS

This application claims benefit under 35 U.S.C. §119(e) to U.S. Provisional Patent Application No. 61/393,230, filed Oct. 14, 2010, and to U.S. Provisional Patent Application No. 61/393,679, filed Oct. 15, 2010, each of which are incorporated by reference in their entirety herein.

### BACKGROUND OF THE INVENTION

The present invention generally relates to marking of products, or parts of products, with ultraviolet (UV) sensitive marking, and products produced in this manner.

There is a problem that counterfeit or parallel import versions of goods may be sold. Because the copy may be a close copy, even a legitimate distributor that does not wish to utilize or sell such illegitimate versions of goods might not be able to tell a legitimate product from a counterfeit one.

### BRIEF SUMMARY OF THE INVENTION

In consideration of the above problems, apparatus and methods are described herein for allowing a product to be marked with a UV sensitive coating, such as UV sensitive ink, or made from, in whole or in part, UV sensitive material. Products made according to the disclosed methods are also provided.

In accordance with a first aspect of the present invention, an apparatus for UV marking a substrate comprises: an ink jet apparatus having UV sensitive ink, the ink jet apparatus being configured to eject the UV sensitive ink; and an extruder producing a wire and insulation in a processing direction. The ink jet apparatus is configured in relation to the processing direction so as to eject UV sensitive ink in a pattern onto a surface of the wire and insulation.

In accordance with a second aspect of the present invention, a method is provided on an apparatus having ink jet apparatus having UV sensitive ink, the ink jet apparatus being configured to eject the UV sensitive ink and an extruder producing a wire and insulation in a processing direction. The method comprises: extruding the wire and insulation in a processing direction; and ejecting the UV sensitive ink in a pattern on a surface of the extruded wire and insulation. In another aspect, a UV marked product is provided that is made by this method.

In accordance with a third aspect of the present invention, an apparatus for forming a UV marked product comprises: first and second injection devices; and a two layer mold injection unit at the output of the first and second injection devices. The first injection device uses a first mixture of a polymer, a color masterbatch, and a UV sensitive masterbatch, and the second injection device uses a second mixture of the polymer and the color masterbatch, and the first mixture and the second mixture are injected into the two layer mold to form a UV marked product having a UV sensitive section and a non-UV sensitive section.

In accordance with a fourth aspect of the present invention, a method is provided on an apparatus comprising: first and second injection devices; and a two layer mold injection unit at the output of the first and second injection devices, for forming a UV marked product. The method comprises: the first injection device outputting into the two layer mold a first mixture of a polymer, a color masterbatch, and a UV sensitive masterbatch; and the second injection device outputting into the two layer mold a second mixture of the polymer and the color masterbatch, and the first mixture and the second mixture are injected into the two layer mold, the two layer mold forming, from the first and second mixture, a UV marked product having a UV sensitive section and a non-UV sensitive section. In another aspect, a UV marked product is provided that is made by this method.

In accordance with a fifth aspect of the present invention, an apparatus for forming a UV marked product comprises: first and second extruder units; and a two or more layer extruder head at the output of the first and second extruder units. The first extruder unit uses a first mixture of a polymer, a color masterbatch, and a UV sensitive masterbatch, and the second extruder unit uses a second mixture of the polymer and the color masterbatch, and the first mixture and the second mixture pass through the two or more layer extruder head to form a UV marked product having a UV sensitive section and a non-UV sensitive section.

In accordance with a sixth aspect of the present invention, a method is provided on an apparatus comprising: first and second extruder units; and a two or more layer extruder head at the output of the first and second extruder units, for forming a UV marked product. The method comprises: the first extruder unit outputting into the two or more layer extruder head a first mixture of a polymer, a color masterbatch, and a UV sensitive masterbatch; and the second extruder head outputting into the two or more layer extruder head a second mixture of the polymer and the color masterbatch, and the first mixture and the second mixture are injected into the two or more layer extruder head, the two or more layer extruder head forming, from the first and second mixture, a UV marked product having a UV sensitive section and a non-UV sensitive section. In another aspect, a UV marked product is provided that is made by this method.

In accordance with another aspect of the present invention, there is provided a product comprising a substrate marked with UV sensitive ink.

In accordance with yet another aspect of the present invention, there is provided a product formed, in whole or in part, of a UV sensitive material.

In accordance with still another aspect of the present invention, there is provided a method for facilitating recognition of whether a manufactured product is a legitimate product or a counterfeit product. The method comprises: marking the legitimate product using UV sensitive material; and determining whether a given product is a legitimate product or a counterfeit product by viewing the given product under UV light, wherein if the product is a legitimate product the UV sensitive material will fluoresce or glow.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1 is a schematic diagram of an apparatus for applying a UV sensitive coating onto a portion of, or all of, a product that is continually extruded in its formation;

FIG. 2 is a schematic diagram of an apparatus for applying a UV sensitive coating onto a portion of, or all of, an object;

FIG. 3 illustrates an example of an inkjet device that can be used in the apparatus in accordance with one aspect of the present invention;

FIGS. 4, 5 and 6 are photographs of color masterbatch, polyolefin, and UV sensitive masterbatch, respectively;

FIG. 7 is a photograph of a dual-injection device that may be used in accordance with aspects of the present invention;

FIG. 8A is a schematic diagram of a single-layer mold injection unit;

FIGS. 9A and 9B are diagrams showing a striped cord and a non-striped cord, respectively, in accordance with aspects of the present invention;

FIG. 10A is a schematic diagram of an apparatus for forming a UV marked product in accordance with aspects of the present invention;

FIG. 10B is a diagram of a two layer head that can be used with two extruders; and

FIGS. 11A and 11B show two exemplary configurations of a jacket and/or insulation in cables or wires that can be made and/or marked in accordance with various aspects of the present invention.

### DETAILED DESCRIPTION OF THE INVENTION

According to an aspect of the present invention, a product can be made to be distinguishable, for example as a legitimate product, by the marking of the product using UV sensitive materials, either in the formation of the product, or by applying UV sensitive coating to all of, or a portion of, the product. The UV sensitive material used in the marking will exhibit a high level of brightness when viewed under a UV light source, causing the product to exhibit the same bright effect under these conditions. The use of UV sensitive materials in accordance the present application is used, e.g., to print on wire, insulation cord, a jacket, jack (overmold) and sliding boot's surface and/or to make such products. In accordance with preferred embodiments, the pattern made by the layout of the UV sensitive materials can be wording and other distinctive patterns.

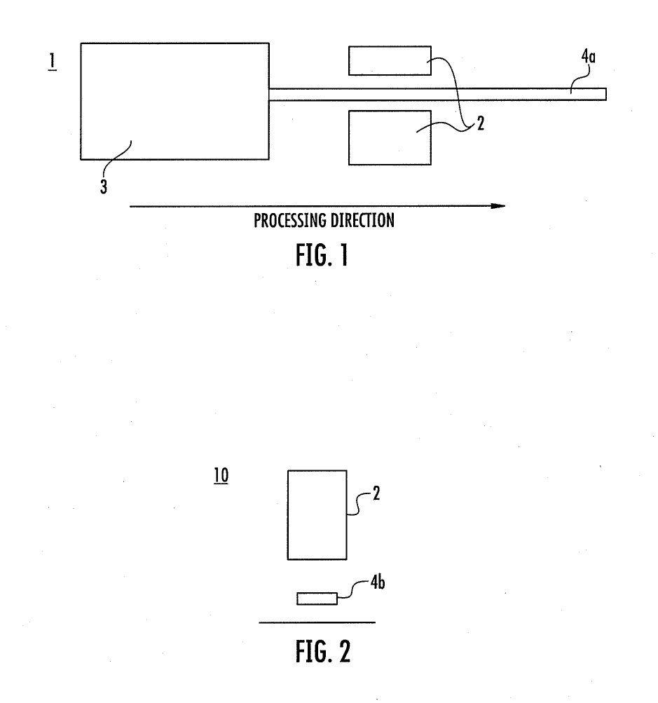

FIG. 1 is a diagram of an apparatus 1 for applying a UV sensitive coating, such as an ink, onto a product that is continually extruded from an extruder 3. As shown in the figure, the apparatus 1 includes an extruder 3 and ink jet device 2. The top portion of the ink jet device 2 is an ink jet head that sprays from the top down. The bottom portion is an ink collecting portion for recycling purposes. The extruder produces an extruded product 4a, such as a wire with insulation or bare wire.

In accordance with one aspect of the present invention, as the extruded product 4a is produced from the extruder 3 in a processing direction, it passes between ink jet portions 2 which at which UV sensitive ink is applied. A pattern, such as wording or letters/numbers, will continually print on the wire surface, in particular on the insulation or jacket.

The UV sensitive ink itself is transparent. However, for color printing, the UV sensitive ink is blended with a colored ingredient, such as a pigment or other colored inks. The UV sensitive ink will cause the product produced by the apparatus 1 to exhibit a bright effect when viewed under UV light. The ratio of colored ink and UV sensitive ink chosen will depend on how strong an effect of brightening is desired. The higher the percentage of UV sensitive ink, the brighter the effect.

The UV ink may be, for example, ink having the following characteristics:

| Chemical name | CAS number | Weight Percentage |
|---|---|---|
| Methyl ethyl ketone (MEK) | 78-93-3 | 60-85 |
| Propylene Glycol Mono- | 107-98-2 | 1-10 |
| Methyl Ether | | |
| Resin | | 3-15 |

Preferably, the product is transparent liquid. The viscosity, fineness, adhesive strength and the drying time will be similar to the regular inkjet printing ink. The product used preferably shows good adhesive strength on many different substrates. The coating would appear as clear or transparent layer. When printing on the substrate, it will not show as a different color between the printed and non printed area. When the printed area is exposed under UV light source, however, the printing will show, for this model ink, bright blue reflected light. The present invention is not limited to this particular UV ink and other appropriate UV inks may be used instead.

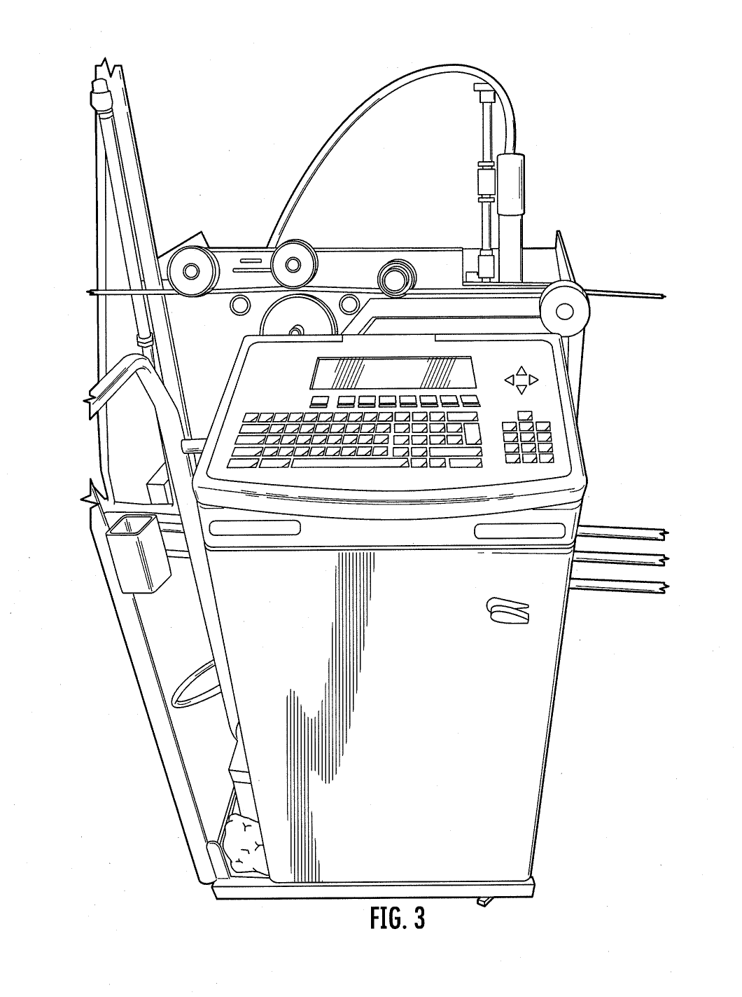

FIG. 2 is a diagram of an apparatus 10 that can be used to apply a UV ink, either alone or mixed with colored ink, as above, onto an individual object 4b using an ink jet 2. Just as in the apparatus shown in FIG. 1, the object that has been applied with the UV ink, either alone or in combination with colored ink, will exhibit the brightening under UV light. In the case of an individual object, an ink jet can be utilized as shown in FIG. 2.

The substrate, i.e., the wire with insulation and/or jacket 4a, or the individual object 4b, can be made of, for example, a polymer (plastic), such as Polyvinyl chloride (PVC), Polypropylene (PP), Polyethylene (PE), Ethylene vinyl acetate (EVA), low smoke zero halogen (LSOH), Fluorinated ethylene propylene (FEP) and Methyl difluoro acetate (MFA). Insulation as the substrate would typically be made from PE. A jacket as the substrate would typically be PVC or LSOH in most cases.

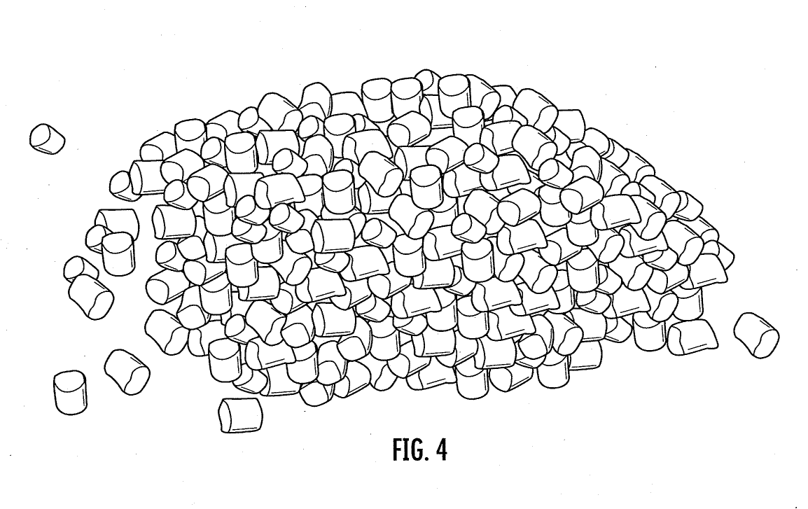

FIG. 3 shows an ink jet device that can be used in accordance with aspects of the present invention for applying the UV ink, using the apparatus of FIGS. 1 and 2. The rollers seen in the figure are part of the extruder line, which is used for wire. The rollers are guides to the hold the wire in the correct position, for example, the correct position for printing on the wire. The device in the figure is an example of a device that can be used. However, as would be understood by those of skill in the art, any device suitable for applying ink to wires and/or conductors, for example, can be utilized in accordance with the present invention.

In order to check an end product made in accordance with the foregoing embodiments, the product would be held under a UV light source. Preferably, the light source used is a strong light with sufficient brightness to reflect from the surface of the product. Under such a light source, the pattern will be easily discernable, e.g., by the naked eye, such that, for example, the UV sensitive ink will fluoresce or glow.

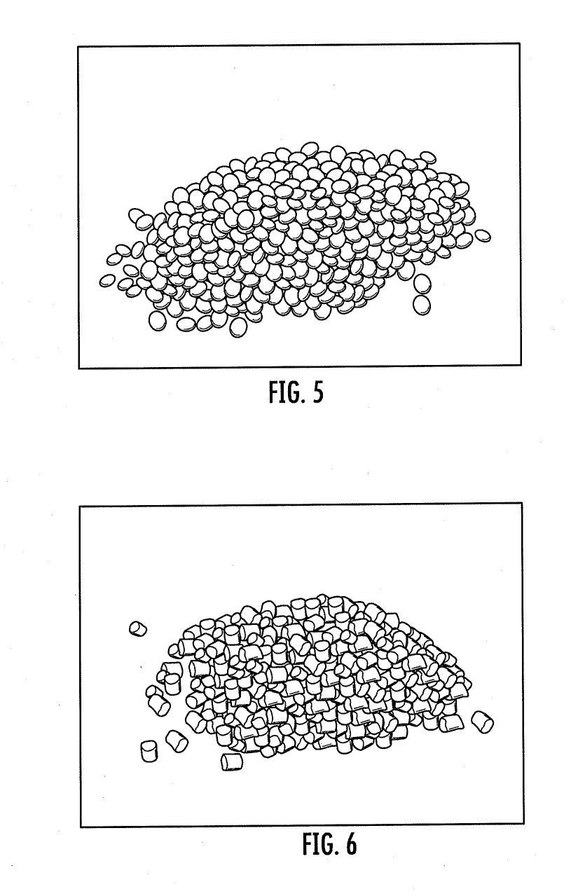

In accordance with another aspect of the present invention, products can be made from, in whole or in part, materials that have a UV sensitive characteristic. Generally speaking, the coloring of polymers, such as those used in insulation, jackets, and the like, involves the use of “masterbatch,” a concentrated mixture of pigments and/or additives encapsulated during a heat process into a carrier resin which is then cooled and cut into a granular shape, as shown, for example, in FIG. 4. Masterbatch allows raw polymer to be economically colored during the plastics manufacturing process. In accordance with an aspect of the present invention, a product made of a polymer can be UV marked by combining the colored masterbatch with a UV sensitive material. An example of such a UV sensitive material is VIBATAN PE Bright Effect 02084, a UV sensitive masterbatch produced by ViBA, as shown in FIG. 6. By using such UV sensitive material, a product can be made so as to have UV sensitive sections that will have a bright light effect under a UV light source, such that, for example, the UV sensitive material will fluoresce or glow. For example, by making a product partly of a UV sensitive material, a pattern can be produced. Alternatively, an entire area of a product can be made from material having UV sensitivity, as will be discussed below.

This particular application can be advantageously utilized in the formation of jacks, plugs and sliding boots. The materials used for the products can be a polymer (plastic), such as Polyvinyl chloride (PVC), Polypropylene (PP), Polyethylene (PE), Ethylene vinyl acetate (EVA), low smoke zero halogen (LSOH), Fluorinated ethylene propylene (FEP) and Methyl difluoro acetate (MFA). A UV sensitive mixture is used in a marking section of the jack, plug and sliding boot. The product is preferably made using an injection device, and can be two layers or a single layer.

To make a UV marked product having a distinctive pattern in accordance with this aspect of the present invention, two injection devices are used. One injection device injects the UV sensitive material, such as PE mixed with UV sensitive masterbatch and colored masterbatch, and the other injects some other color material, such as PE mixed with colored masterbatch. The two injection devices connect with a two layer mold. If the entire over-mold section of the product is to have the UV sensitive effect, a single injection unit can be used with a one layer mold.

FIGS. 4, 5 and 6 show, respectively, Blue or other color masterbatch, Polyolefin (such as Polyethylene (PE)), and UV sensitive masterbatch (such as vibatan pe bright effect 02484). In the case that the UV sensitive parts of the product are arranged in a distinctive pattern, two different mixtures of compound will be used for each injection device, with a dual layer mold. For the section having UV sensitivity, PE, color masterbatch and UV sensitive masterbatch are mixed together to form a mixture, which is used for one injection unit. To form the non-UV sensitive part, a mixture of PE and color masterbatch is used in another injection device.

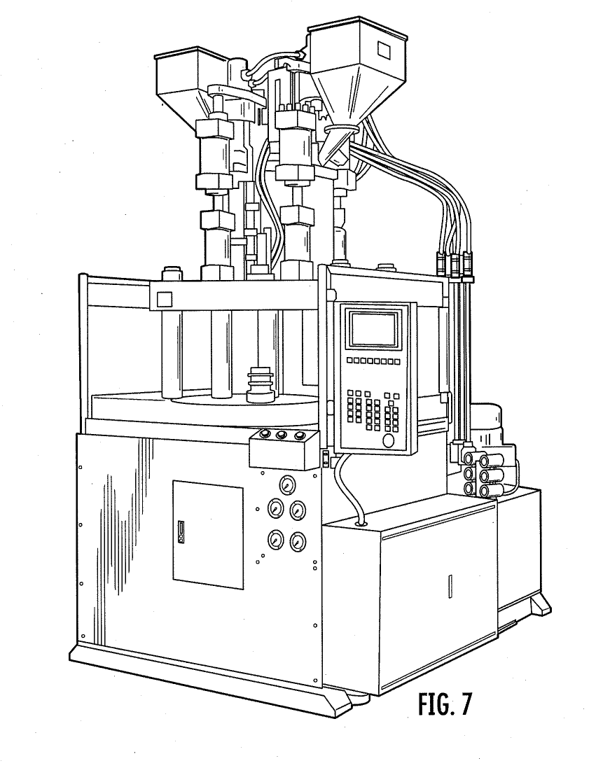

An example of a dual injection device suitable for use in marking with a UV pattern is shown in FIG. 7. The device shown in the figure is an example of a device that is suitable for use in accordance with the disclosed embodiments. However, as would be understood by those of skill in the art, any suitable injection device can be utilized.

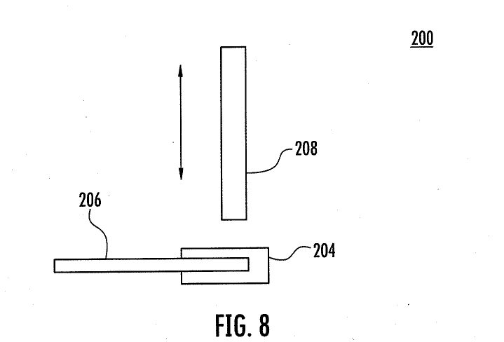

If the entire over-mold is to exhibit UV sensitivity, the compound is blended from color masterbatch and UV sensitive masterbatch, together with PE. The blended mixture can be injected using a single injection device and a single layer mold injection unit. A schematic diagram of such a device is shown in FIG. 8. The device 200 has an injection mold 204, an assembly unit 206 and an injection unit 208. The assembly unit 206 is removed from the mold after injection. During injection, the injection unit 208 will go down towards the injection mold 204. After the injection, the injection unit 208 returns to its original position.

In order to check a product made by either of these processes, a generic UV light source can be used. The UV light source should be strong and bright enough to reflect light from the product substrate surface, such that, for example, the UV sensitive material will fluoresce or glow.

The end product of this process can be checked under a UV light, which should be strong and bright enough to reflect from the substrate's surface.

Another aspect of the present invention allows for the preparation of UV marked wire, insulation and jacket surfaces. Once again, the marking according to this aspect can be used to distinguish a product from a fake or parallel import product selling at, for example, a local distributor. The process in this aspect relates to the wire, insulation and jacket.

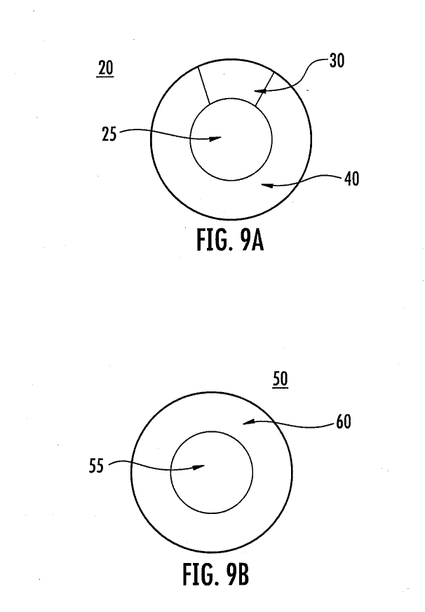

FIGS. 9A and 9B are cross-sectional views of a striped cord, having a UV sensitive stripe, and a non-striped cord, using UV sensitive material for the entire insulation, respectively. FIG. 9A shows a striped cord or wire 20 that has a conductor 25, made, for example, out of a conducting metal. The conductor 25 is surrounded by an insulation or jacket that comprises a UV sensitive portion 30 of the insulation or jacket and a non-UV portion 40 of the insulation or jacket. A wire formed in this manner will have a stripe that exhibits brightness under UV light exposure. The material from which the insulation/jacket is made can be, for example, a polymer (plastic), such as Polyvinyl chloride (PVC), Polypropylene (PP), Polyethylene (PE), Ethylene vinyl acetate (EVA), low smoke zero halogen (LSOH), Fluorinated ethylene propylene (FEP) and Methyl difluoro acetate (MFA). The wire can include both an insulator and a jacket, or any combination as is known in the art.

The basic material of the insulation/jacket of the striped cord 20 is preferably PE. The UV sensitive section 30 will preferably be made out of PE, color master batch, and a UV sensitive masterbatch. This mixture is used to make the stripe. The ratio of color masterbatch to UV sensitive masterbatch in the mixture will depend on the desired hue. The non-UV sensitive section 40 is made of PE and color masterbatch. As in the embodiments discussed above, the UV sensitive masterbatch can be vibatan pe bright effect 02484.

FIG. 9B shows a non-striped cord or wire 50, having a UV sensitive insulation/jacket 60 made entirely from a mixture including UV sensitive material, and a conducting core 55. In this case, the UV sensitive section 60 will preferably be made out of PE, color master batch, and a UV sensitive masterbatch. This mixture is used to make the stripe. The ratio of color masterbatch to UV sensitive masterbatch in the mixture will depend on the desired hue.

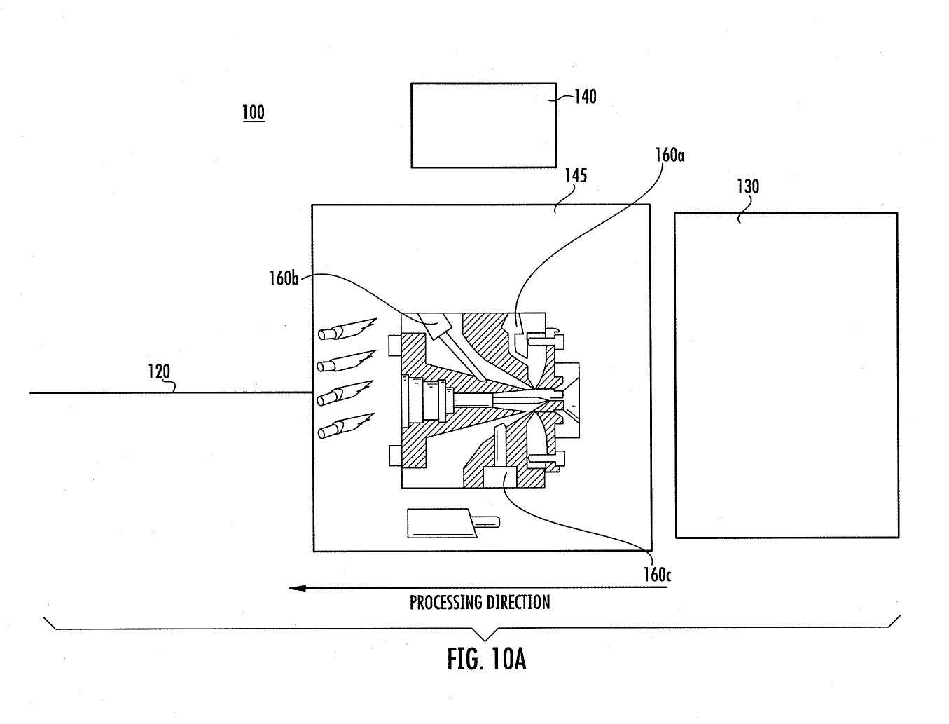

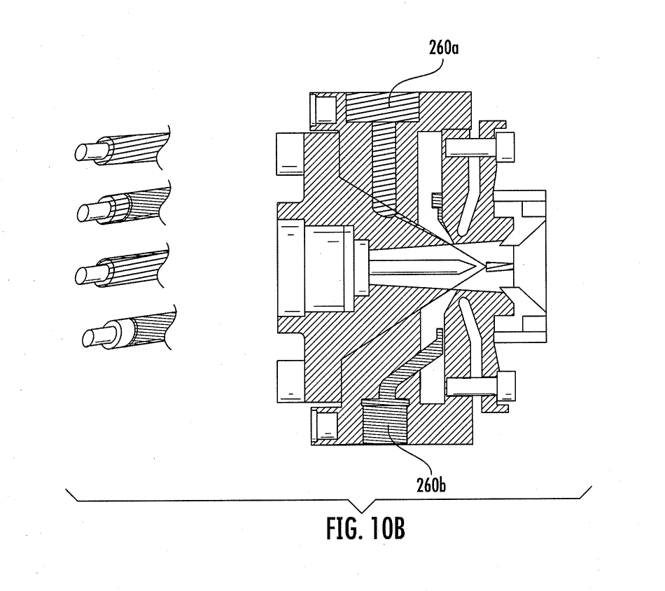

The process for making a striped cord in accordance with this aspect of the present invention will be discussed making reference to the diagram of FIG. 10A. The process for forming the wire and insulator/jacket uses extrusion, and most preferably utilizes a cross-head extrusion process, in which the flow of plastic is altered to allow a solid material, such as a wire, to feed into the melt flow of the plastic. In the case of making a striped cord, the insulated cord 120 having such a stripe is produced by two extruder units, a first extruder unit 130 and a second extruder unit 140. The outputs of the two extruder units are fed to an extruder head 145. Preferably the material that includes the UV sensitive material as discussed above, which will form the stripe, is used in the extruder unit 140, while the material for forming the non-UV sensitive section, as discussed above, is used in the extruder unit 130.

In the process, preferably both extrusions start at the same time and the end product is produced after passing through the extruder cross head 145 in the processing direction. The cross head is preferably at minimum a two layer type, and preferably a three layer type, as shown in the figure. In the three layer cross head shown in the figure, there are three plastic inlet locations 160a, 160b and 160c, which can be used, for example, to mix three different colors from three extruders. A two layer type head for use with two extruders is shown in FIG. 10B and can be used in the apparatus shown in FIG. 10A in place of the three layer head. The head shown in FIG. 10B has two plastic inlet locations 260a and 260b. Various jacket/insulation configurations that can be made by this head are shown at the left portion of FIG. 10B. Although particular cross-head configurations are shown in the figures, any known, e.g. two or three layer, cross head can be utilized in accordance with the embodiments of the present invention.

For making a non-striped UV marked cord 50, the same apparatus can be utilized. However, in this case only the material having UV sensitivity is used, preferably from extruder unit 130.

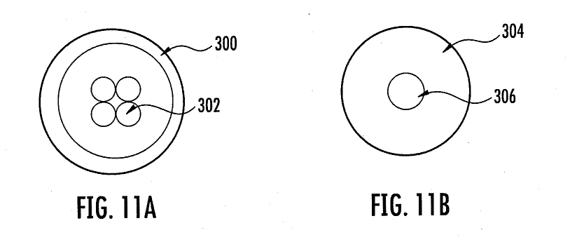

FIGS. 11A and 11B show two exemplary configurations of a jacket and/or insulation in cables, as shown, for example, in FIG. 11A, or wires, as shown in FIG. 11B, that can be made and/or marked in accordance with various aspects of the present invention. As shown in FIG. 11A, a cable comprising insulation and cord 302 is formed inside of a jacket 300. In FIG. 11B, a cord 306 with insulation 304 is formed. In addition, individual wires and/or cables can be wound or twisted/braided together in patterns using alternating UV marked and non-UV marked wires and/or cables.

As in the other aspects of the present invention, the end product can be checked by using a UV light source that produces light that is strong and bright enough to reflect from the substrate's surface, such that, for example, the UV sensitive material will fluoresce or glow in the presence of UV light.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. For example, wires made by the above methods can be wound together to form cables, e.g., using alternating UV marked and unmarked wires. Therefore, it is intended that this invention be limited only by the claims and the equivalents thereof.

What is claimed is:

1. An apparatus for UV marking a substrate, the apparatus comprising:
an ink jet apparatus having UV sensitive ink, the ink jet apparatus being configured to eject the UV sensitive ink; and
an extruder producing a wire and insulation in a processing direction,
the ink jet apparatus being configured in relation to the processing direction so as to eject UV sensitive ink in a pattern onto a surface of the wire and insulation.

2. A method on an apparatus having ink jet apparatus having UV sensitive ink, the ink jet apparatus being configured to eject the UV sensitive ink and an extruder producing a wire and insulation in a processing direction, the method comprising:
extruding the wire and insulation in a processing direction; and
ejecting the UV sensitive ink in a pattern on a surface of the extruded wire and insulation.

3. A UV marked product made by the method of claim 2.

4. A product comprising a substrate marked with UV sensitive ink.

5. An apparatus for forming a UV marked product, the apparatus comprising:
first and second injection devices; and
a two layer mold injection unit at the output of the first and second injection devices,
wherein the first injection device uses a first mixture of a polymer, a color masterbatch, and a UV sensitive masterbatch, and the second injection device uses a second mixture of the polymer and the color masterbatch, and the first mixture and the second mixture are injected into the two layer mold to form a UV marked product having a UV sensitive section and a non-UV sensitive section.

6. A method, on an apparatus comprising: first and second injection devices; and a two layer mold injection unit at the output of the first and second injection devices, for forming a UV marked product, the method comprising:
the first injection device outputting into the two layer mold a first mixture of a polymer, a color masterbatch, and a UV sensitive masterbatch; and
the second injection device outputting into the two layer mold a second mixture of the polymer and the color masterbatch, and the first mixture and the second mixture are injected into the two layer mold,
the two layer mold forming, from the first and second mixture, a UV marked product having a UV sensitive section and a non-UV sensitive section.

7. A UV marked product made by the method of claim 6.

8. A product formed, in whole or in part, of a UV sensitive material.

9. An apparatus for forming a UV marked product, the apparatus comprising:
first and second extruder units; and
a two or more layer extruder head at the output of the first and second extruder units,
wherein the first extruder unit uses a first mixture of a polymer, a color masterbatch, and a UV sensitive masterbatch, and the second extruder unit uses a second mixture of the polymer and the color masterbatch, and the first mixture and the second mixture pass through the two or more layer extruder head to form a UV marked product having a UV sensitive section and a non-UV sensitive section.

10. A method, on an apparatus comprising: first and second extruder units; and a two or more layer extruder head at the output of the first and second extruder units, for forming a UV marked product, the method comprising:
the first extruder unit outputting into the two or more layer extruder head a first mixture of a polymer, a color masterbatch, and a UV sensitive masterbatch; and
the second extruder head outputting into the two or more layer extruder head a second mixture of the polymer and the color masterbatch, and the first mixture and the second mixture are injected into the two or more layer extruder head,
the two or more layer extruder head forming, from the first and second mixture, a UV marked product having a UV sensitive section and a non-UV sensitive section.

11. A UV marked product made by the method of claim 10.

12. A method for facilitating recognition of whether a manufactured product is a legitimate product or a counterfeit product, the method comprising:
marking the legitimate product using UV sensitive material; and
determining whether a given product is a legitimate product or a counterfeit product by viewing the given product under UV light, wherein if the product is a legitimate product the UV sensitive material will fluoresce or glow.
